(19) United States
(12) Patent Application Publication
(10) Pub. No.: US 2013/0249903 A1
(43) Pub. Date: Sep. 26, 2013

(54) MEDICAL IMAGE DISPLAY DEVICE, MEDICAL INFORMATION MANAGEMENT SERVER

(71) Applicants: Miho Isokawa, Sagamihara (JP); Hanae Yoshida, Yokohama (JP); Michio Oikawa, Machida (JP)

(72) Inventors: Miho Isokawa, Sagamihara (JP); Hanae Yoshida, Yokohama (JP); Michio Oikawa, Machida (JP)

(73) Assignee: HITACHI, LTD., Tokyo (JP)

(21) Appl. No.: 13/876,059

(22) PCT Filed: Oct. 13, 2010
(86) PCT No.: PCT/JP2010/067929

§ 371 Date: Jun. 6, 2013

(51) Int. Cl. G06T 7/00

(52) U.S. Cl. CPC G06T 7/0012
USPC 345/419

(57) ABSTRACT

A medical image display device 20 of the present invention includes: a storage unit 34 that saves medical images, ROI information indicating the position of a three-dimensional region in the medical images, and diagnostic information corresponding to the ROI information; and a control unit that stores, for each of the multiple diagnostic information when the multiple diagnostic information exist for the single medical image, a parameter setting used for displaying the medical image at the time each of the diagnostic information is imparted by a user, and a severity indicating the priority of the parameter setting to be used when displaying the medical image on a display unit, in the storage unit 34 in association with each other.

### TECHNICAL FIELD

The present application claims benefit of the filing date of Japanese Patent Application No. PCT-JP2010-067929 filed on Oct. 13, 2010 which is incorporated herein by reference.

The present invention relates to a technique that creates, stores and displays diagnostic information against medical images collected by a medical imaging device such as a MRI (Magnetic Resonance Imaging) device and a CT (Computed Tomography) device.

### BACKGROUND OF INVENTION

In recent years, it is possible to collect a large amount of cross-sectional images, accompanied with the sophistication of a medical imaging devices such as a MRI device and a CT device. In addition, it is possible to generate, draw and process three-dimensional data out of cross-sectional images fast and with a high degree of accuracy, accompanied with sophistication of medical image display device. Therefore, it is possible to view medical images under a variety of display settings.

It is often the case that diagnostic information is shared among a plurality of users such as a radiological technician to perform imaging operation of medical images, a physician to perform interpretation of radiogram (diagnosis based on medical images) (hereinafter referred to as a “reading doctor”), and a physician to perform a physical examination of the patient based on diagnostic information (diagnostic information based on the medical images performed by a reading doctor) (hereinafter referred to as a “consultation doctor”), and it is important to select the appropriate display setting when creating and displaying diagnostic information.

U.S. Patent Application Publication No. 2004/0254763 A1 suggests a method of storing observation progress information and observations in the database in such a manner that they are correlated to one another, and reproducing the observation progress information when viewing information. U.S. Patent Application Publication No. 2004/0059214 A1 suggests a method, by specifying a three-dimensional ROI (Region of Interest) in a two-dimensional section, to display the region crossing the three-dimensional ROI in the image of another section and to extract sections crossing the three-dimensional ROI. Japanese Patent Application No. H06-208608A suggests a method, by specifying annotations (information such as findings and instructions imparted to ROI) for the three-dimensional coordinates on an arbitrary cross section generated from a three-dimensional image, to display the annotations at a corresponding position of another cross-sectional image.

### SUMMARY OF INVENTION

### Description of Related Art

Medical images based on three-dimensional data can be browsed under various display settings, but an appropriate display setting should be selected when diagnostic information is displayed on the screen, since the diagnostic information is shared among many users. For example, there is a case that a tumor clearly viewable in medical images under some display setting (such as point of view and parameter settings) is not well viewable in medical images under other display setting.

In addition, it is desirable that even diagnostic information imparted to a ROI selected under a specific display setting is to be drawn on medical images under other display settings if the ROI is included in the drawing region.

Further, when multiple pieces of diagnostic information are associated with an identical medical image, each piece of diagnostic information can be imparted under different display settings, thus there is a need to specify one piece of diagnostic information to reflect the display setting per screen.

Also, when there are many pieces of diagnostic information, it is necessary to indicate the existence of many pieces of diagnostic information without inhibiting the viewing field.

There is a problem that the prior arts described above cannot respond to these requirements.

The present invention is made in view of the aforesaid problems, in order to display medical images and diagnostic information appropriately on the screen.

### Means for Solving Problems

In order to solve the above problems, a medical image display device of the present invention includes: a storage unit that saves medical images, ROI information indicating the position of a three-dimensional region in the medical images, and diagnostic information corresponding to the ROI information; and a control unit that stores, for each of the multiple diagnostic information when the multiple diagnostic information exist for the single medical image, a parameter setting used for displaying the medical image at the time each of the diagnostic information is imparted by a user, and a severity indicating the priority of the parameter setting to be used when displaying the medical image on a display unit, in the storage unit in association with each other.

Other means will be described later.

### Effects of Invention

According to the present invention, it is capable to display the medical image and the diagnostic information properly on the screen.

### BRIEF DESCRIPTION OF DRAWINGS

FIG. 1 is a block diagram of a medical image display device and a medical information management server according to an embodiment of the present invention.

FIG. 2A is a diagram showing a data structure of a medical image.

FIG. 2B is a diagram showing a data structure of diagnostic information.

FIG. 3A is a flowchart showing a process of imparting diagnostic information to a medical image.

FIG. 3B is a flowchart showing a process of displaying a medical image and diagnostic information.

FIG. 4 is a flowchart showing a detailed process of specifying and displaying a ROI.

FIG. 5A is a diagram showing a diagnostic object and a cross-section of a medical image in the three-dimensional space.

FIG. 5B is an explanatory diagram for the ROI on a cross-sectional image of the two-dimensional display.

FIG. 5C is an explanatory diagram in the three-dimensional display when expanding the ROI three-dimensionally.

FIG. 5D is an explanatory diagram in the three-dimensional display for the results of the ROI expanded three-dimensionally.

FIG. 6 is a state transition diagram of the diagnostic information state.

FIG. 7A is an example of a screen of the display unit.

FIG. 7B is a diagram showing an outline of a piece of diagnostic information in the list table of diagnostic information summary.

FIG. 8A is an explanatory diagram of a diagnostic object, a cross-section, three-dimensional ROIs and icons in three-dimensional space of a medical image.

FIG. 8B is an explanatory diagram of the ROIs and the icon on a cross-sectional image of the two-dimensional display.

FIG. 9 is a diagram showing the layout of a report.

### LEGEND FOR REFERENCE NUMERALS

1 Medical image management server
2 Control unit
3 Storage unit
4 Data receiving part
5 Storage processing part
6 Data request receiving part
7 Search processing part
8 Data transmitting part
20 Medical image display device
21 Input unit
22 List management unit
23 Data request transmission unit
24 Data reception unit
25 Data transmission unit
26 Display unit
30 Diagnostic information process unit
31 Coordinate conversion unit
32 Image generation unit
33 Display control unit
34 Storage unit
40 Network
41 Medical imaging device
42 Hospital information system

### EMBODIMENT OF INVENTION

Hereinafter, embodiments for implementing a medical image display device and a medical information management server according to the present invention will be described with reference to accompanying drawings.

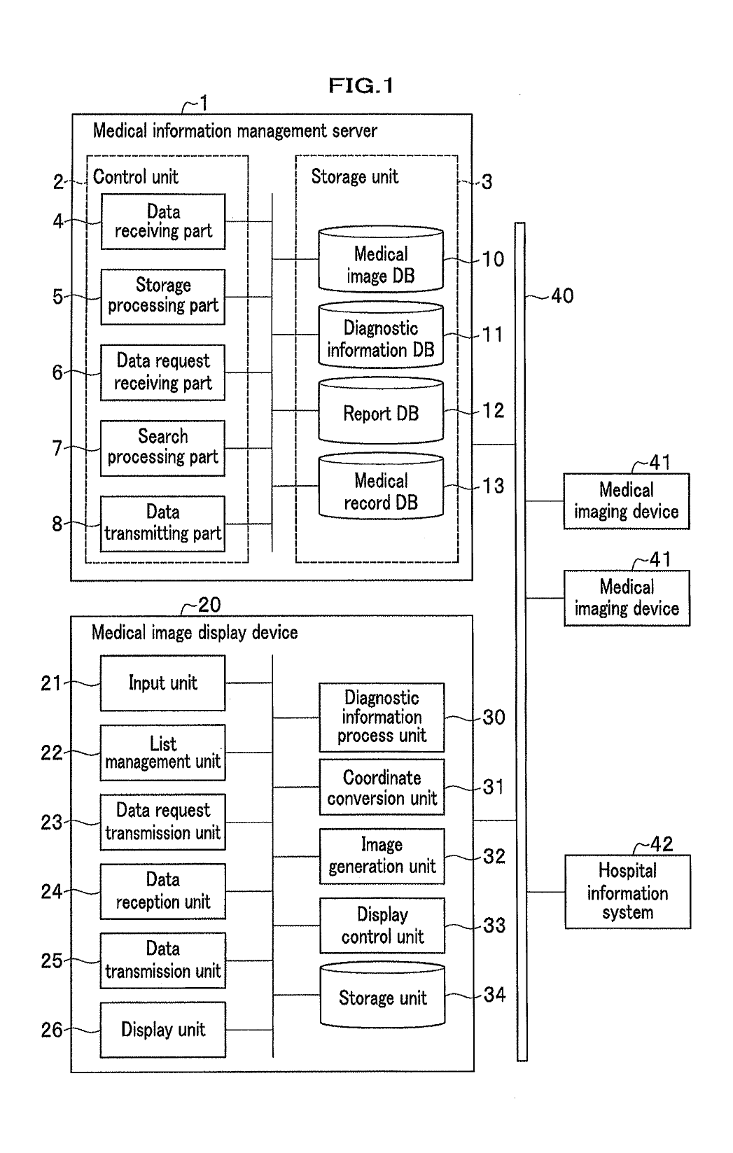

First, the structure of a medical image display device and a medical information management server according to the present embodiment will be described with reference to FIG. 1.

After the imaging operation, a medical imaging device 41 such as a MRI device and a CT device sends cross-sectional images taken thereby to a medical information management server 1 through a network 40. Here, the network 40 may be, for example, either an intranet within a hospital, an inspection agency or the like, or the internet.

The medical information management server 1 is a so-called PACS (Picture Archiving and Communication System) server, intended to manage medical information such as medical images, diagnostic information and patient information, and consists of a control unit 2 and a storage unit 3.

The control unit 2 includes: a data receiving part 4 that receives data from the medical imaging device 41, a medical image display device 20, and a hospital information system 42 to manage information such as patient information, examination information, accounting information or the like; a storage processing part 5 that stores data by selecting a database (one of multiple databases in the storage unit 3); a data request receiving part 6 that receives a data request from the medical image display device 20; a search processing part 7 that retrieves data corresponding to the data request from the database (one of multiple databases in the storage unit 3); and a data transmitting part 8 that transmits data to the requester, i.e. the medical image display device 20. The control unit 2 is implemented, for example, using a CPU (Central Processing Unit) and a memory.

In addition, the storage unit 3 includes: a medical image DB (Data Base) 10 that contains medical images such as cross-sectional images collected from the medical imaging device 41 and medical images generated by the medical image display device 20; a diagnostic information DB 11 that contains diagnostic information generated by the medical image display device 20; a report DB 12 that contains reports created in the medical image display device 20; and a medical record DB 13 that contains information about the patient. The storage unit 3 is implemented, for example, using a HDD (Hard Disk Drive) or the like.

It should be noted that the medical information management server 1 may be provided with all these databases, a plurality of medical information management server 1 having a specific database(s) may be used in conjunction with each other or many others, or with a hospital information system 42 holding an equivalent database(s). Also, a single database may contain multiple kinds of information such as medical images, diagnostic information and reports.

The medical image display device 20 is a computer device for displaying a medical image by connecting to the medical information management server 1 and acquiring medical image data, and for entering diagnostic information by reading doctors, composed of a CPU, a memory, a ROM (Read Only Memory), a HDD, an input/output interface, a LCD (Liquid Crystal Display), a keyboard, and a mouse, for example.

The medical image display device 20 includes: an input unit 21 that processes input from users; a list management unit 22 that maintains a list of reading requests and a list of medical information to be displayed; a data request transmission unit 23 that transmits a data request to the medical information management server 1; a data reception unit 24 that receives data from the medical information management server 1; a data transmission unit 25 that transmits data to the medical information management server 1; a display unit 26 that has a screen to display medical images; a diagnostic information processing unit 30 (the control unit) that processes diagnostic information; a coordinate conversion unit 31 (the control unit) that manages coordinates of data space of medical images and convert two-dimensional coordinates to three-dimensional coordinates or vice versa; an image generation unit 32 (the control unit) that processes medical images; a display control unit 33 (the control unit) that controls for display such as to manage the position of elements to display on the screen; and a storage unit 34 that temporarily stores medical images and diagnostic information.

It should be noted that the medical image display device 20 may be a device that is primarily intended to browse medical images and diagnostic information, without inputting new diagnostic information.

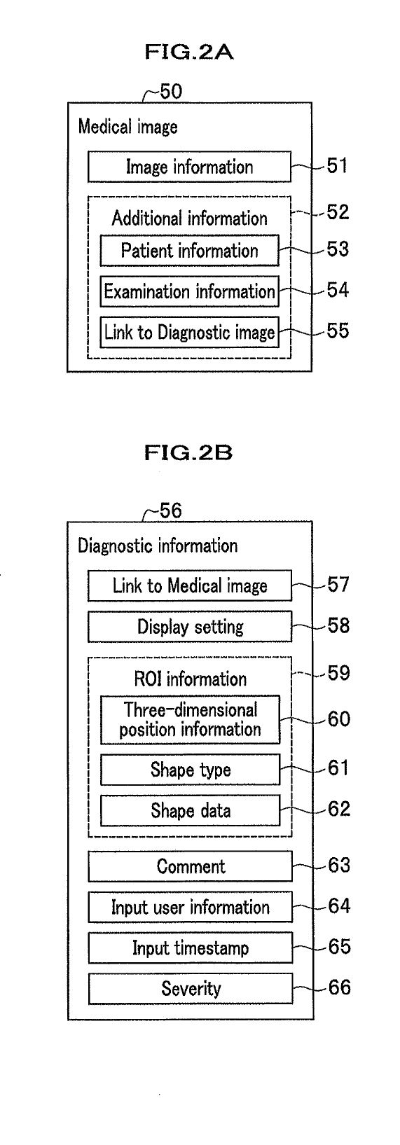

Described next will be an example of the configuration of the medical information maintained in the medical information management server 1. As shown in FIG. 2A, a medical image 50 includes additional information 52 such as patient information 53, examination information 54, and a link-to-diagnostic-image 55, in addition to image information 51 such as pixel values.

As shown in FIG. 2B, diagnostic information 56 is intended to be imparted in association with the medical image 50 by the medical image display device 20 and includes: a link-to-medical-image 57 to be diagnosed; a display setting 58 such as a display mode and parameters when the diagnosis is performed; ROI information 59 (three-dimensional position information 60, a shape type 61, and shape data 62 of the ROI); a comment 63 that shows the results of diagnosis; input user information 64; an input timestamp 65; and, a severity 66 (the priority of a parameter setting to be used when displaying medical images on the display unit 26). In addition to these, information about the access rights may be included, for example.

It should be noted that the medical image 50 and the diagnostic information 56 may not include all of the elements (information) described in FIGS. 2A and 2B, or may also include other elements by changing the configuration, if necessary. Further, the diagnostic information 56 may be included in the additional information 52 of the medical image 50.

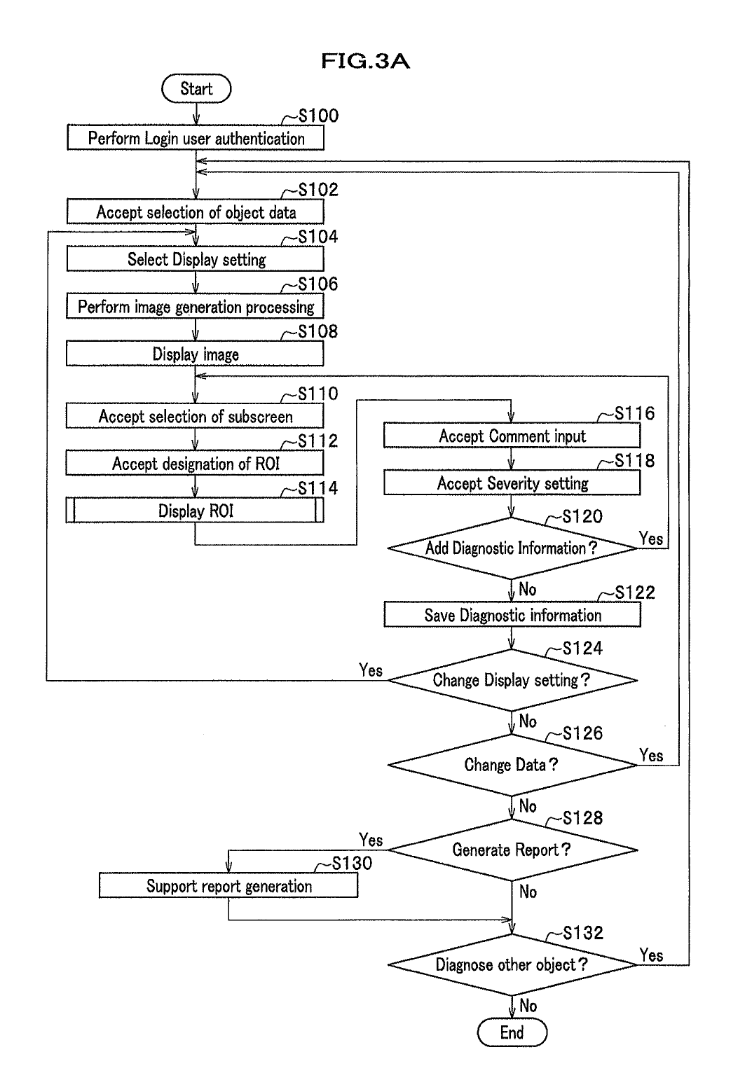

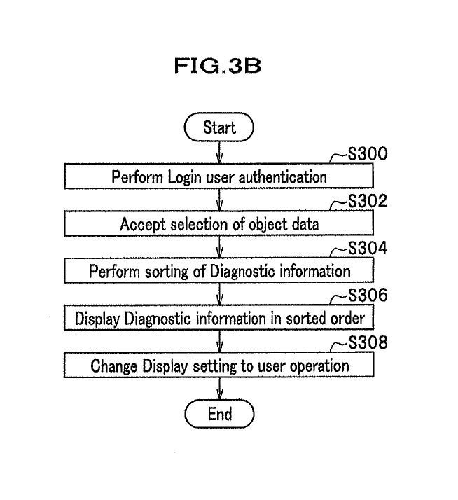

Then, the outline of the flow by inputting the diagnostic information 56 using the medical image display device 20 (see FIGS. 1 and 2 as appropriate) will be described with reference to FIG. 3A. Here, a user is assumed to be a reading doctor in the radiological department or the like, who receives reading requests.

The user performs a login operation at the medical image display device 20, which in turn performs a process of login user authentication (S100). Here, as the validity of the user is confirmed by performing user authentication, processes associated with the user, such as list generation of medical information to be diagnosed and registration of input user information for creating diagnostic information, are automatically performed in subsequent processing.

The user selects medical information to be diagnosed, either from a list of reading requests created by the list management unit 22 or by searching object data using a patient name, an examination name, a collective name of medical images or the like as a key, and the medical image display device 20 accepts the selection of the object data (S102). Depending on the selection, the data request transmission unit 23 transmits a data request to the data request receiving part 6 of the medical information management server 1. The search processing part 7 of the medical information management server 1 retrieves requested information by searching the storage unit 3, and the data transmitting part 8 sends the adapting information to the medical image display device 20.

Once the data reception unit 24 of the medical image display device 20 receives a medical image, the image generation unit 32 selects a display setting (S104), performs an image generation processing (S106), and displays the image on the screen of the display unit 26 (S108). It should be noted that the display setting may be selected from typical configuration template which is prepared in advance in accordance with the purposes of the examination, or may be freely set by the user. In addition, when there is diagnostic information 56 associated with the medical image 50, the display setting 58 contained in the diagnostic information 56 may be selected.

The display setting includes information such as a screen layout that divides a screen of the display unit 26 into a plurality of subscreens, a display mode of each of the subscreens, and display parameters in each display mode.

Examples of the display mode are a two dimensional display mode (a display mode using cross-sectional images of axial, coronal and sagittal planes obtained from the medical imaging device 41, or arbitrary cross-sectional images according to a MPR (Multi-Planar Reconstruction)), or a three-dimensional display mode (a display mode according to a VR (Volume Rendering), a SR (Surface Rendering), a MIP (Maximum Intensity Projection), a MinIP (Minimum Intensity Projection), a VE (Virtual Endoscopy) or the like).

Examples of the display parameters are a window level, a window width, an opacity curve, a color assignment, a light source, and a viewing position.

The medical image display device 20 accepts the selection of the arbitrary subscreen by the user (S110), accepts a designation of a ROI (Region of Interest) for a region to be noted in order to perform the diagnosis on the subscreen by the user (S112), displays the ROI (S114), and accepts comment input by the user (S116).

It should be noted that methods to specify the ROI are, for example, using an input device such as a mouse, a manual drawing, arranging basic shapes (a circle, a rectangular, or the like in case of two dimensional display, and a sphere, a cuboid, a cylinder, a cone, or the like in case of three-dimensional display), a region growing method to specify the starting point and the threshold value, selecting a region out of the divided regions, or the like.

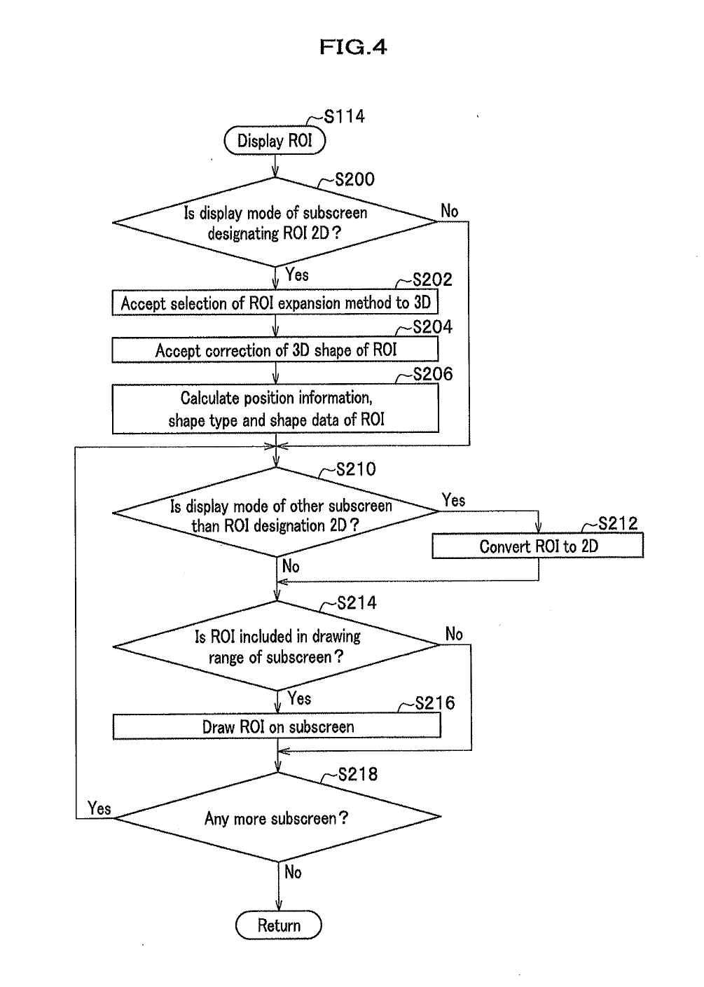

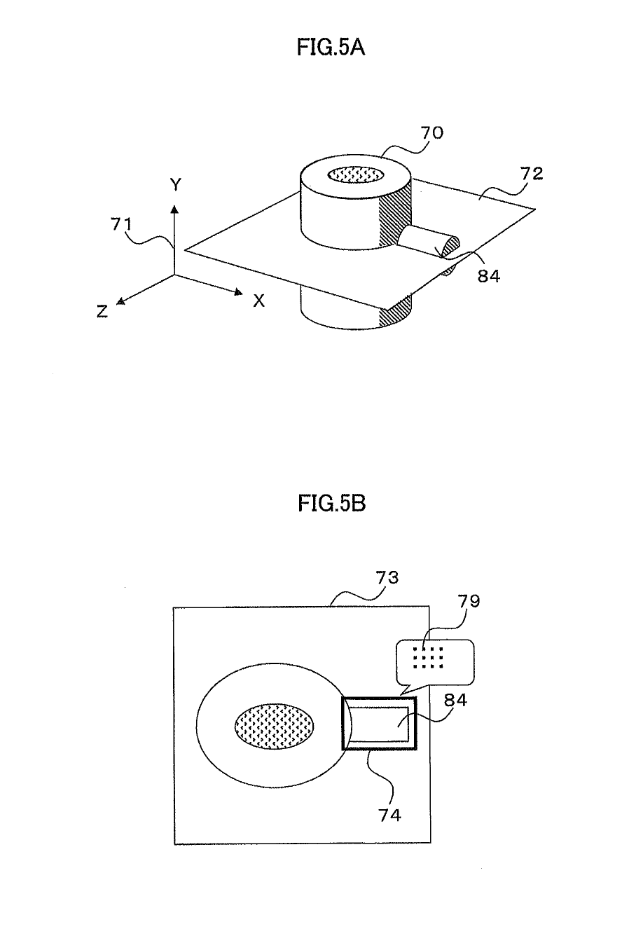

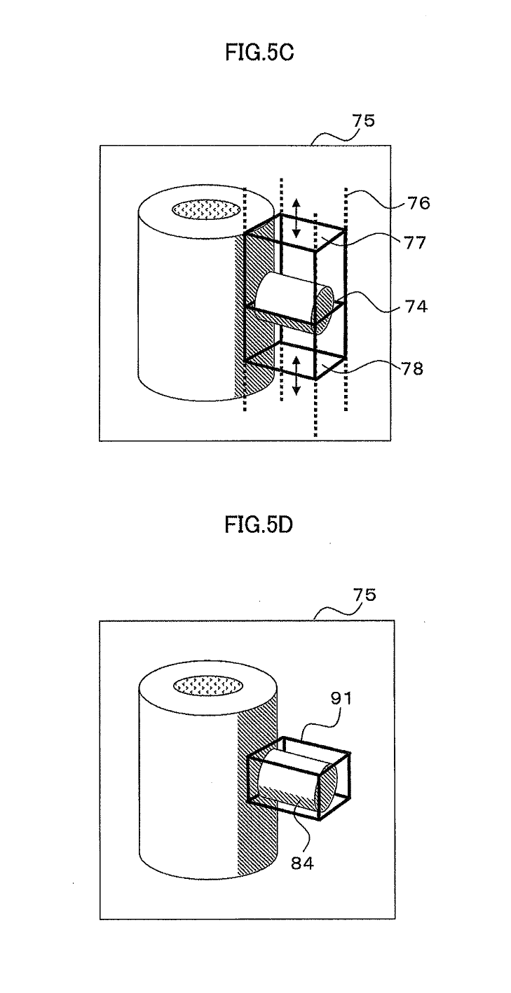

Details of the flow from the designation of the ROI (S112) to the display of the ROI (S114) will be described with reference to FIG. 4 and FIGS. 5A to 5D. First, when the display mode of the subscreen in which the ROI was designated (S112) is two-dimensional (2D in short) (Yes at S200), the medical image display device 20 accepts the selection made by the user expanding the ROI to be present on the two-dimensional plane to a three-dimensional (3D in short) space (S202).

There are multiple choices for the way of expanding to the three-dimensional space, and specifically the medical image display device 20 accepts one selected by the user from methods such as a method to regard the ROI exists only on a two-dimensional plane in the three-dimensional space, a method to translate the ROI in the direction of the axis perpendicular to the two-dimensional plane, a method to expand the region included in the ROI using a region growing method in the direction of the axis perpendicular to the two-dimensional plane or the like (S202). Then, the medical image display device 20 performs a three-dimensional display by the display control unit 33 on another subscreen from that of the two-dimensional display, accepts correction on the shape of the ROI (three-dimensional shape) by the user in the direction of the axis perpendicular to the two-dimensional plane (S204), and calculates the three-dimensional position information of the ROI, the shape type, and the shape data by the coordinate conversion unit 31 (S206).

FIG. 5B shows a subscreen 73 which is a cross-sectional view of a diagnostic object 70 in three-dimensional space as shown in FIG. 5A, transected with a two-dimensional plane 72 in parallel to the X-Z plane of axes 71. The display mode of the subscreen 73 as shown in FIG. 5B is two-dimensional, and a selection list of expanding methods to three-dimension space is displayed in a balloon 79, when the user designates a two-dimensional rectangular as a ROI 74, using the input unit 21, so as to surround a protruding region 84 included in the diagnostic object 70.

Here, if a selection is made to designate the ROI as a three-dimensionally expanded region along the axis Y perpendicular to the two-dimensional plane 72, those displayed on a subscreen 75 shown in FIG. 5C and having three-dimensional display mode are the ROI 74 on the two-dimensional plane 72, a line 76 that extends four vertices of the ROI 74 in the direction of axis Y, a top surface 77 and a bottom surface 78 which are obtained by translating the ROI 74. The user is free to determine the shape of the three-dimensional ROI, by translating the top surface 77 and the bottom surface 78 either with a drag using a mouse or the like as the input unit 21 or with numeric input using a keyboard or the like as the input unit 21. As a result of determining the shape, the shape of three-dimensional ROI 91 surrounding the protruding region 84 is fixed, as shown in FIG. 5D.

Returning to FIG. 4 and continuing with the description, the medical image display device 20 then determines, for all other subscreens except the one in which the ROI was designated, whether or not the display mode is two-dimensional (S210). If the display mode is three-dimensional (No at S210), the medical image display device 20 treats the ROI as it is, and if the display mode is two-dimensional (Yes at S210), the medical image display device 20 converts the ROI from three-dimensional to two-dimensional by calculating the intersecting region of the two-dimensional plane and the three-dimensional ROI (S212).

The medical image display device 20 determines whether or not the ROI is included in the drawing range of the subscreen (S214), and if the ROI is included therein (Yes at S214), the ROI is drawn on the subscreen (S216). The ROI drawing method is, for example, surrounding the outer periphery by a colored line, semi-transparent masking the elements in the ROI or the like.

The medical image display apparatus 20 performs the same processing for all other subscreens except the one in which the ROI was designated (S218). That is, if there is an unchecked subscreen (Yes at S218), the process returns to S210, and if there is no unchecked subscreen (No in S218), the process proceeds to S116.

Returning to FIG. 3A and continuing with the description, the medical image display device 20 then accepts an input of comments by the user for the ROI such as findings using the input unit 21 (S116), and thereafter accepts a severity setting by the user in accordance with the diagnosis results (S118).

If diagnostic information is added under the same display setting (Yes at S120), the process returns back to select a subscreen (S110), and if a display setting is to be changed (Yes at S124) after saving diagnostic information (S122), the process returns back to select a display setting (S104), and further if data is to be changed (Yes at S126), the process returns back to select data (S102), thereby repeating the same process.

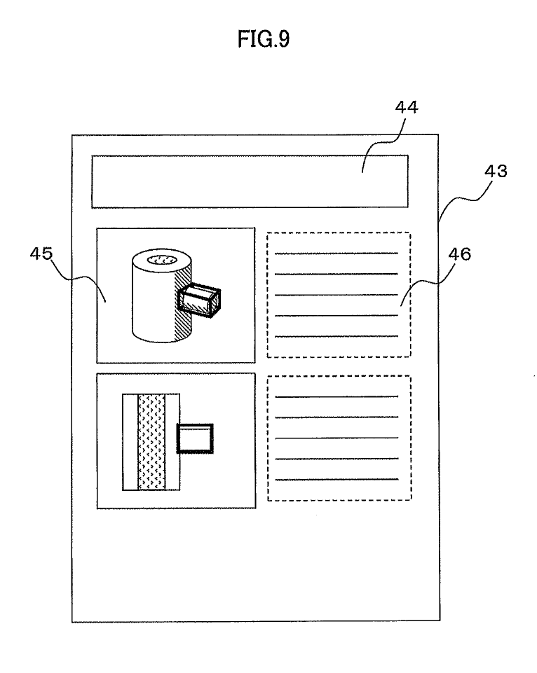

When the user confirms to output (generate) the diagnostic results as a report 43 (see FIG. 9) (Yes at S128), the medical image display device 20 supports the user to generate a report using the input unit 21 (S130). In this case, the report generation conducted by the user is supported in such a way that the diagnostic information process unit 30 extracts information of the medical image to be reported, the report author information and others, while the display control unit 33 enters input in a report information section 44 of the report 43 (see FIG. 9). In addition, for one or more diagnostic information 56 (see FIG. 2B) selected by the user to output a report, the diagnostic information processing unit 30 extracts information included in each diagnostic information 56 such as an image drawn using the display setting 58 included in each diagnostic information 56, the comment 63 included in the diagnostic information 56, the input user information 64, the input timestamp 65, while the display control unit 33 places a combination of an image 45 and the information 46 in accordance with the format of the report layout, and saves the report in the storage unit 34. Further, the data transmission unit 25 sends the report to the report DB 12 in the medical information management server 1 or the hospital information system 42.

The image 45 is intended to be drawn in accordance with the display setting 58 included in the diagnostic information 56, wherein only the diagnostic object 70 and the ROI of the diagnostic information are drawn. A layout format and a file format of the report 43 may be set by the user.

Next, an overview of the process flow for displaying the diagnostic information 56 using the medical image display device 20 will be described. Here, the user is assumed to be a consultation doctor who performs examination with reference to the reading result.

As shown in FIG. 3B, the user performs a login operation to the medical image display device 20, which in turn performs a process of login user authentication (S300). The user selects object data to be displayed, either from a list of reading results created by the list management unit 22 or by searching object data using a patient name, an examination name, a collective name of medical images or the like as a key, and the medical image display device 20 accepts the selection of the object data (S302). Depending on the selection, the data request transmission unit 23 transmits a data request to the data request receiving part 6 of the medical information management server 1. The search processing part 7 of the medical information management server 1 retrieves requested information by searching the storage unit 3, and the data transmitting part 8 sends the adapting information to the medical image display device 20.

The data reception unit 24 of the medical image display device 20 receives the medical image 50 and the diagnostic information 56, then the diagnostic information process unit 30 performs sorting of the diagnostic information (S304). Sorting is performed using the severity 66 of the diagnostic information 56 as a first condition, and if there are a plurality of diagnostic information 56 having the same severity 66 specified, the sorting is performed using items such as the input user information 64, the input timestamp 65, the ROI region, and the three-dimensional position information 60 of the ROI as a second and third conditions. The user can specify the sorting condition. In addition, it is also possible to limit the diagnostic information to be displayed by filtering the diagnostic information 56 using a variety of conditions.

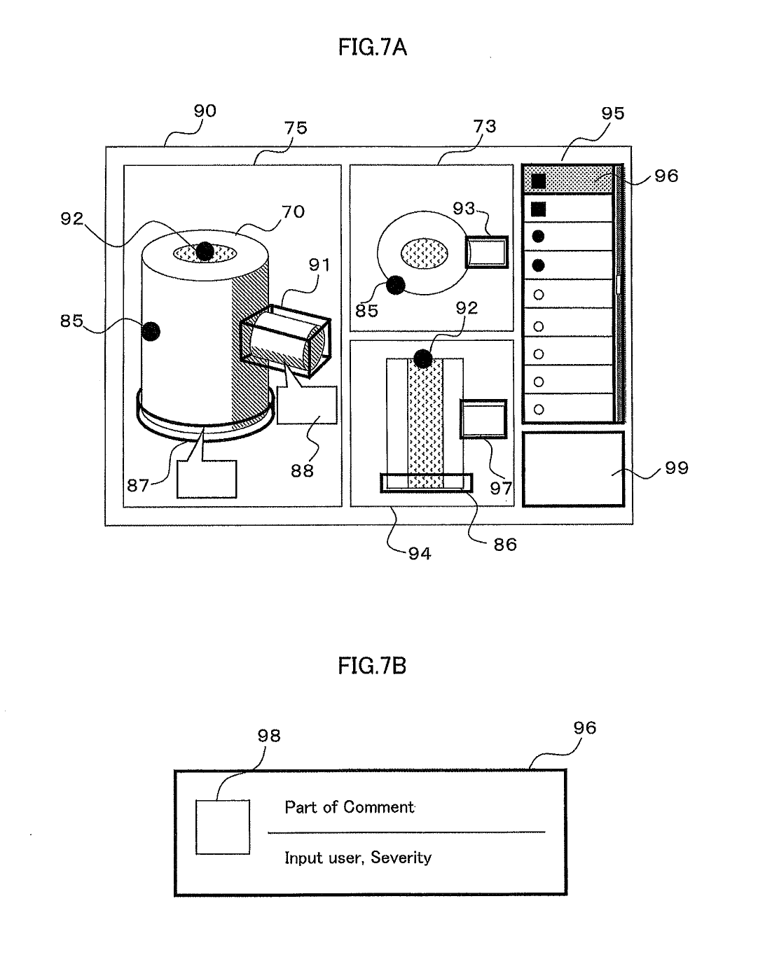

The diagnostic information process unit 30 extracts information characterizing the diagnostic information 56 such as a part of the comment 63 and the input user information 64, then displays the diagnostic information in the sorted order at a diagnostic information list table 95 on a screen 90 of the display unit 26 (see FIG. 7A) (S306). At this time, the display control unit 33 adds a scroll bar to the list table 95 in case of many pieces of diagnostic information and displays information in the order of priority. It should be noted that the list table 95 may be displayed at all times on the screen 90 or may be hidden if necessary.

Afterward, the medical image display device 20 changes a display setting according to a user operation (S308). This will be described in detail hereinafter.

When one of subscreens 73, 75, and 94, each displays a medical image, is selected by the user with a click, the subscreen turns into an active state. An image generated using the display setting 58 of the diagnostic information 56 having the highest-priority is displayed on the active subscreen as the initial state, but it is also possible to change the display setting 58 by a user operation.

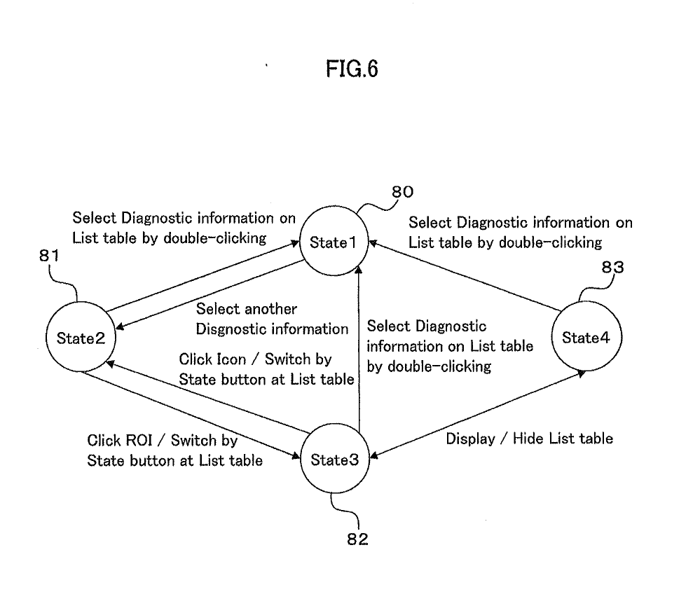

Displaying the ROI information 59, included in the diagnostic information 56, on the medical image 59 is classified into four states described below based on the user selection and the priority, and a state transition follows display rules (conditions) as shown in FIG. 6.

State 1 (reference numeral 80): perform an image generation process reflecting the display setting, and highlight the ROI (highlight)

State 2 (reference numeral 81): keep the display setting unchanged (unreflected), and highlight the ROI (highlight)

State 3 (reference numeral 82): place an icon, indicating that there is a ROI, in the center coordinates of the ROI (icon).

State 4 (reference numeral 83): hide the ROI (hide).

For each subscreen, State 1 is assigned to a single diagnostic information 56, and States 2-4 are assigned to other diagnostic information. When the active subscreen is switched, the state assigned to the diagnostic information 56 is switched, but the order in the list table 95 does not change. Details on these will be described later with reference to FIG. 7A.

The diagnostic information in States 1, 2, and 3 is accompanied with drawing if a ROI is included in the drawing area in the subscreens 73, 75, and 94, but there is no drawing for the diagnostic information in State 4. Note that it is possible to set for the ROI located at the rear side or inside of the diagnostic object 70 whether or not the ROI is displayed in the foreground on the subscreen 75 having a three-dimensional display mode.

Highlighting in States 1 and 2 means to draw a border that shows the outline of the ROI and to display information that characterizes the diagnostic information 56, such as a part of the comment and the input user, in a balloon 88. The position of the balloon 88 is automatically placed, not overlapping the diagnostic object 70 on the screen as much as possible and being close to the ROI, by the display control unit 33, so as not to interfere with the diagnosis by the user. In addition, it is possible to set for each subscreen whether to display or hide the balloon 88.

Each diagnostic information summary 96 is displayed in the list table 95 (see FIG. 7A), in the order sorted by the diagnostic information process unit 30. As shown in FIG. 7B, the diagnostic information summary 96 includes a state button 98 to indicate and switch the state, and information that characterizes the diagnostic information 56, such as a part of the comment and the input user. Note that the severity 66 of the diagnostic information 56 may be displayed in literal notation in the diagnostic information summary 96, or the background color may be changed by the severity 66. If the diagnostic information summary 96 is clicked, information included in the diagnostic information 56 such as a full text of the comment 63, input user information 64 and the timestamp 65 are displayed in a diagnostic information detail 99.

In FIG. 7A, the four states of the diagnostic information is distinguished as follows in the list table 95;

State 1: shaded background, the state button is a filled rectangle (▪)

State 2: the state button is a filled rectangle (▪)

State 3: the state button is a filled small circle ()

State 4: the state button is a white small circle (∘)

It should be noted that these states 1 to 4 correspond to the states 1 to 4 mentioned earlier.

If one of the diagnostic information summary 96 is selected by double-clicking thereon, the selected diagnostic information 56 transits to State 1 (see FIG. 6), while the diagnostic information 56 having State 1 until then transits to State 2. If either one of icons 85 and 92 that is drawn in subscreens 73, 75, and 94 as State 3 and indicates the position of the ROI in the diagnostic information 56, the display mode transits to State 2 wherein the ROI is changed in highlighted display instead of the icon. Further, if the highlighted ROI described above is clicked, the display mode returns to an icon in State 3. Initially the diagnostic information 56 at the top of the list table is in State 1, while other diagnostic information at the upper level is in State 3 and other diagnostic information at the lower level is in State 4. The user can set a boundary condition between the upper and lower level.

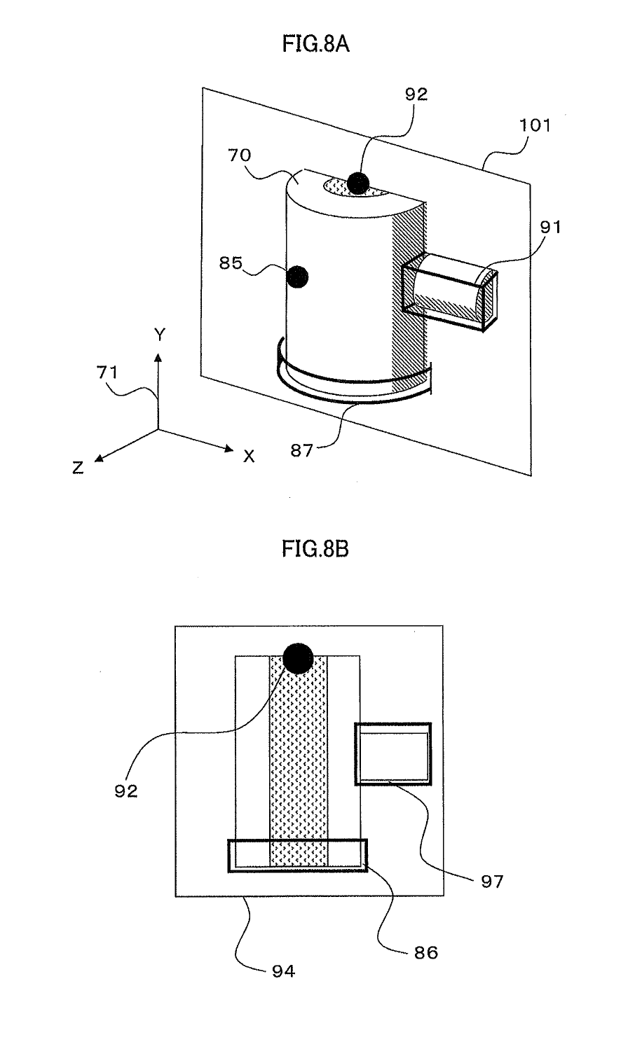

The display mode of the subscreen 75 is a three-dimensional display mode in FIG. 7A, and a cross-sectional view obtained by cutting a diagnostic object 70 with a two-dimensional plane 101, which is in parallel to the X-Y plane of the coordinate axes 71 of the three-dimensional space in FIG. 8A and passes through the icon 92, is a subscreen 94 (see FIG. 8B). Here, three-dimensional ROIs 87, 91 on the subscreen 75 in a three-dimensional display mode are displayed on the subscreens 73 and 94 in a two-dimensional subscreen display mode as two-dimensional ROIs 86, 93, and 97 represented by the border of the area where the three-dimensional ROI 91 and each two-dimensional plane corresponding to each subscreen cross.

On the screen 90 in FIG. 7A, the topmost diagnostic information summary 96 (hereinafter referred to simply as “diagnostic information”) out of the diagnostic information displayed in the list table 95 is in State 1 (shaded background, ▪), thus the corresponding ROIs are highlighted as ROIs 91, 93, and 97 in subscreens. Further, when the subscreen 75 is active, the display setting for the subscreen 75 reflects the display setting 58 included in this diagnostic information 56. The second topmost diagnostic information is in State 2 (▪), and the corresponding ROIs are highlighted as the ROIs 86 and 87.

The third and fourth topmost diagnostic information are in State 3 (), thus the positions of the corresponding ROIs are indicated by the icons 85 and 92. Since the position of the icon 92 in three-dimensional space is present on a two-dimensional plane 101 (see FIG. 8A), the icon 92 is displayed on the subscreen 94 too. Similarly, the icon 85 is displayed not only on the subscreen 75 but also on the subscreen 73.

It should be noted that the state of the diagnostic information (State 1 to 4) may be set as common for all subscreens on the screen or may be set different for each subscreen.

In addition, if the diagnostic information associated with the object medical image is already present when adding diagnostic information as shown in the flowchart in FIG. 3A, the existing diagnostic information may be displayed on the screen according to the procedure described above. Further, it is also possible to add new diagnostic information when displaying the medical image according to the procedure described above.

Thus, the medical image 50 and the diagnostic information 56 can be displayed properly on the screen by the medical image display device 20 according to the present embodiment, by saving display settings 58 (such as parameter settings and Severity) that were used to display the medical image 50 when the user added the diagnostic information 56, in association with the diagnostic information 56.

Also, even when the user enters the ROI information regarding the two-dimensional image of the medical image 50, the medical image 50 can be displayed properly on the screen, by converting the ROI information to the position and shape in three-dimensional space of the medical image 50 corresponding to the ROI information thereof then saving the converted data.

Further, if more than one diagnostic information 56 are present for a single medical image 50, the proper medical image 50 can be displayed, by displaying the medical image 50 on the display unit based on the display setting corresponding to the diagnostic information 56 having the highest severity.

Furthermore, when more than one diagnostic information 56 are present, the proper medical information 56 can be displayed, by classifying the display mode of the ROI into a highlighted display, an icon display and hiding according to the severity. In other words, it is possible to avoid a situation that viewing field of medical image 50 is inhibited by displaying all diagnostic information.

Still Furthermore, when storing the medical image 50 and the diagnostic information 56 in the database, the medical information management server 1 according to the present embodiment can contribute to the proper display of the medical image 50 and the diagnostic information 56 on the medical image display device 20, by correlating the position and shape in three-dimensional space in the ROI information, the parameter setting and the severity as the diagnostic information 56.

What is claimed is:

1. A medical image display device comprising:
a storage unit that saves medical images, ROI (Region Of Interest) information indicating the position of a three-dimensional region in the medical images, and diagnostic information corresponding to the ROI information; and
a control unit that stores, for each of the multiple diagnostic information when the multiple diagnostic information exist for the single medical image, a parameter setting used for displaying the medical image at the time each of the diagnostic information is imparted by a user, and a severity indicating the priority of the parameter setting to be used when displaying the medical image on a display unit, in the storage unit in association with each other.

2. The medical image display device according to claim 1,
wherein the control unit:
displays two-dimensional image of the medical image on one of a plurality of subscreens of the display unit; and when the user inputs the ROI information regarding the two-dimensional image,
converts the ROI information, in accordance with the input by the user, to information of the position and shape in three-dimensional space of the medical image then saves the converted data in the storage unit.

3. A medical image display device, which displays diagnostic information associated with medical images, comprising:
a storage unit that saves medical images, ROI (Region Of Interest) information indicating the position of a three-dimensional region in the medical images, and diagnostic information corresponding to the ROI information; and
a control unit that displays, when the multiple diagnostic information exist for the single medical image, a list of the multiple diagnostic information on a display unit as well as the medical image based on the display setting corresponding to the diagnostic information having the highest severity, which priority is assigned to each of the multiple diagnostic information in advance.

4. The medical image display device according to claim 3, wherein
the storage unit saves a display rule to classify a display mode of the ROI for each diagnostic information into any of multiple display methods including a highlighted display, an icon display and hiding, according to the severity of each of the multiple diagnostic information, and
the control unit displays the each ROI corresponding to the multiple diagnostic information on the display unit, based on the display rule.

5. A medical information management server comprising:
a storage unit having database that saves medical images and diagnostic information; and
a control unit,
wherein the control unit stores the diagnostic information into the database, by correlating the position and shape in three-dimensional space of the ROI information, the display parameter setting and the severity, handled by the medical image display device according to claim 2, as the diagnostic information.
